(19) United States
(12) Patent Application Publication
(10) Pub. No.: US 2018/0010053 A1
(43) Pub. Date: Jan. 11, 2018

(54) HYDRO DISAMBIGUATIVE CATALYTIC DONOR RECOMBINATION, PROCESS AND APPARATUS

(71) Applicant: Rajah Vijay KUMAR, Bangalore (IN)

(72) Inventor: Rajah Vijay Kumar, Bangalore (IN)

(21) Appl. No.: 15/539,231

(22) PCT Filed: Jan. 28, 2015
(86) PCT No.: PCT/IN2015/000053

§ 371 Date: Jun. 23, 2017

(51) Int. Cl. C10G 3/00; B01J 23/89

(52) U.S. Cl. CPC C10G 3/52; C10G 3/45; B01J 23/892; C10G 2300/202

(57) ABSTRACT

A Hydro Disambiguative Catalytic Donor Recombination process and apparatus that uses Water, Sunlight (for energy) and any Organic liquid carbon donor source (Plant (vegetable oils) and Animal Fat (fortified butter or ghee) to produce flammable fuel consisting of C₁ to C₈ Hydrocarbons, and we call this gas as Organic Petroleum Gas (NPG), which has the same composition as a petroleum gas obtained from fossil source.

### BACKGROUND

### Field of the Invention

This invention relates to Hydro Disambiguative Catalytic Donor Recombination, process and apparatus which is used for producing organic petroleum gas from non-petroleum materials/products.

Fuels are any materials that store potential energy in forms that can be practicably released and used for work or as heat energy. The concept originally applied solely to those materials storing energy in the form of chemical energy that could be released through combustion, but the concept has since been also applied to other sources of heat energy such as nuclear energy (via nuclear fission or nuclear fusion).

The first known use of fuel was the combustion of wood or sticks by Homo erectus nearly 2,000,000 (two million) years ago. Throughout most of human history fuels derived from plants or animal fat were the only ones humans used. Charcoal, a wood derivative, has been used since at least 6,000 BCE for melting metals. It was only supplanted by coke, derived from coal.

Coal was first used as a fuel around 1000 BCE in China and India. With the development of the steam engine in 1769, coal came into more common use as a power source. Coal was later used to drive ships and locomotives. By the 19th century, gas extracted from coal was being used for street lighting in cities like London. In the 20th and 21st centuries, the primary use of coal is to generate electricity, providing 40% of the world's electrical power supply.

Fossil fuels were rapidly adopted during the industrial revolution, because they were more concentrated and flexible than traditional energy sources, such as water power. They have become a pivotal part of our contemporary society, with most countries in the world burning fossil fuels in order to produce power. Currently the trend has been towards renewable fuels, such as biofuels like bio-methane and alcohols.

Fuel gas is any one of a number of fuels that under ordinary conditions are gaseous. Many fuel gases are composed of hydrocarbons (such as methane, propane or butane etc.) or a mixture of hydrogen and carbon monoxide. Such gases are sources of potential heat energy or light energy that can be readily transmitted and distributed through pipes from the point of origin directly to the place of consumption. Fuel gas is contrasted with liquid fuels and from solid fuels, though some fuel gases are liquefied for storage or transport. While their gaseous nature can be advantageous, avoiding the difficulty of transporting solid fuel and the dangers of spillage inherent in liquid fuels, it can also be dangerous, if adequate care is not taken. Most of the fuels used today are from one or the other fossil sources.

Fossil fuels are non-renewable resources because they take millions of years to form, and reserves are being depleted much faster than new ones are being made. So we must conserve these fuels and use them judiciously. The production and use of fossil fuels raise environmental concerns. A global movement toward the generation of renewable energy is therefore under way to help meet increased energy needs. The burning of fossil fuels produces around 21.3 billion tons of carbon dioxide (CO₂) per year, but it is estimated that natural processes can only absorb about half of that amount, so there is a net increase of 10.65 billion tonnes of atmospheric carbon dioxide per year (one tons of atmospheric carbon is equivalent to 44/12 or 3.7 tons of carbon dioxide). Carbon dioxide is one of the greenhouse gases that enhances radiative forcing and contributes to global warming, causing the average surface temperatures of the planet to rise in response.

Fuel Poverty

A person is to be regarded as living “in fuel poverty” if he is a member of a household living on a lower income in a home which cannot be kept warm and cook basic food at a reasonable cost. Statistically this used to be defined when a household would need to spend more than 10% of its income to maintain an adequate heating and basic cooking regime (definitions of “income” and “adequate heating and basic cooking regime” vary between Country to country.) A new more complex definition of fuel poverty is now used in some countries. Fuel poverty is now defined as when a household's required fuel costs are above the median level; and if they were to spend what is required, then the household would be left with a residual income below the official poverty line. Additionally, a Fuel Poverty Indicator has been created, which shows how far into fuel poverty households are, not simply if they are in poverty or not. Fuel poverty, may not be only due to economic reasons alone but lack of any access to energy infrastructure, or even shortage of fuel can give raise to fuel poverty. The sharp rise in fuel prices from 2006 has led to an estimated doubling of the numbers in fuel poverty in countries where it is a major problem. A number of illnesses, including cancer can exacerbate the problems associated with fuel poverty.

Water:

Water is the greatest source of energy, the most unique chemical substance in the universe. Water is life and Water is fire. A verse from the ancient Rig-Veda describes it all . . .
Yasu Raja Varuno Yasu Samo Vishwai Deva Yasurjam Madanti|
Vaishwanaro Yaswagnih Prarvishtasta Apao Devirih Mamvantu∥
   VII.49.4
“The water in which the king of waters Varuna dwells, the water in which “Som”lives, in whom all gods drink exhilarating strength, the waters in which the leader of all Agni (fire)enters, who are full of divine values, helping) me and the world”

It is said that there will be a great war for water; definitely it will not be for drinking water but it is going to be for the enormous energy that is trapped in water.

### Prior Art

U.S. Pat. No. 5,149,407 discloses a method of and apparatus for obtaining the release of a fuel gas mixture including hydrogen and oxygen from water wherein the water molecules are broken down into hydrogen and oxygen gas atoms in a capacitive cell by a polarization and resonance process dependent upon the dielectric properties of water and water molecules. The gas atoms are thereafter ionized or otherwise energized and thermally combusted to release a degree of energy greater than that of combustion of the gas in ambient air.

WO 2010131086 A2 discloses a compact and portable system adapted for use in decomposing water and separating an oxygen rich gaseous stream and a hydrogen rich gaseous stream that produces an output of hydrogen fuel along with the proportional amount of oxygen capable of operating at varying levels of user output, on-demand. This system can interface easily with existing technologies to power standard motor vehicles including gas, diesel, ethanol or hydrogen systems, recreational vehicles, home energy systems and home appliances, commercial/industrial power generators, smelters, fuel cells and much more.

Though there are a number of patents and publications relating to production of fuel gas, there is no mention of a process of producing petroleum products out of non-petroleum materials and also this is the only process known to first break down a non-petroleum material consisting of hydrogen and carbon and then reassemble the hydrogen and carbon into petroleum hydrocarbon conventionally found only in fossil fuels.

This invention proposes_a method and an apparatus that uses Water, Sunlight (for energy) and any Organic liquid carbon donor source (Plant (vegetable oils) and Animal Fat (fortified butter or ghee) to produce flammable fuel consisting of C₁ to C₈ Hydrocarbons. We call this gas as Organic Petroleum Gas (OPG), which has the same composition as a petroleum gas obtained from fossil source. The process and apparatus will be known as HYDRODECIDER coined from the expression “HYDRO DisambiguativE CatalytIc Donor REcombination Reactor”. The process stated in this invention is called “Vijay-Rajah HYDRODECIDER process” named after its Inventor. In this specification the term ‘process water’ denotes drinking water boiled for 20 minutes and cooled to room temperature.

### SUMMARY OF THE INVENTION

This invention provides Hydro Disambiguative Catalytic Donor Recombination, process for producing flammable fuel consisting of C₁ to C₈ hydrocarbons, called as ‘Organic Petroleum Gas’ comprising the steps of:
a. subjecting process water to high frequency resonance inside a reactor equipped with a special Nickel-Platinum-Palladium super catalyst to disambiguate water into nascent Hydrogen (H⁺) and monatomic Oxygen (O⁻);
b. holding the short lived nascent species of monatomic hydrogen in an Ionic Stabilizer containing Arsenic as a catalyst to prolong without mingling with each other;
c. passing the Nascent Hydrogen and Oxygen species through Monatomic Accelerator, which is subjected through a very high polarized electrical field on the opposite sides, where there is continuous atomic attraction and repulsion so as to maintain the required atomic state but also accelerate the said species towards the Active High Velocity Plunger;
d. plunging the nascent species into a reactor holding a carbon source donor such as used vegetable oil or animal fat, in the presence of a copper complex catalyst at high velocity to produce the flammable fuel consisting of C₁ to C₈ hydrocarbons;
e. storing the gas thus formed in a buffer storage tank at a safe pressure.

The Hydro Disambiguative Catalytic Donor Recombination apparatus of the present invention comprises of a Fuel Tank that contains is ok of process water (1), a Catalytic Disambiguation Reactor (CDR) (2), CDR also houses the Nickel substrate (2A) and the Nickel-Platinum-Palladium catalyst (2B), Ionic Stabilizer (3), Monatomic Accelerator (4), Active high velocity plunger (5), a Carbon Donor Reactor (CADR) (6), which consists of the Copper Complex Catalyst (6A) and the Carbon Donor Fluid (6B), a Buffer Storage system (7), a Flow Meter (8). The Electronics of the system consist of a High Frequency Resonance Generator (9), tuned to an appropriate frequency, i.e. a tuned resonating frequency that is determined by the reactor design, this is known to anyone working with resonance circuits in electronics, a solar panel, batteries, power control system and all the process control automation (10).

### BRIEF DESCRIPTION OF THE ACCOMPANYING DRAWINGS

FIG. 1 is an isometric view of the apparatus of the present invention; and

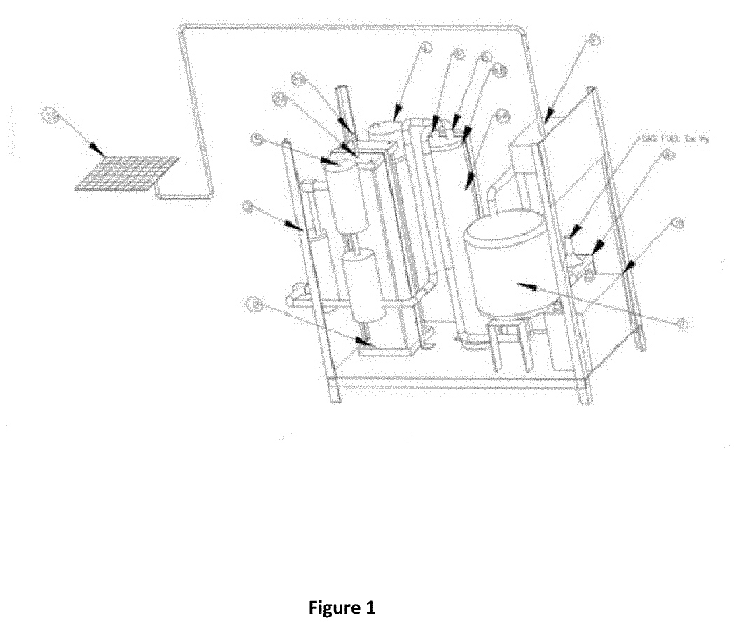

FIG. 2 is a cross-sectional view of the apparatus.

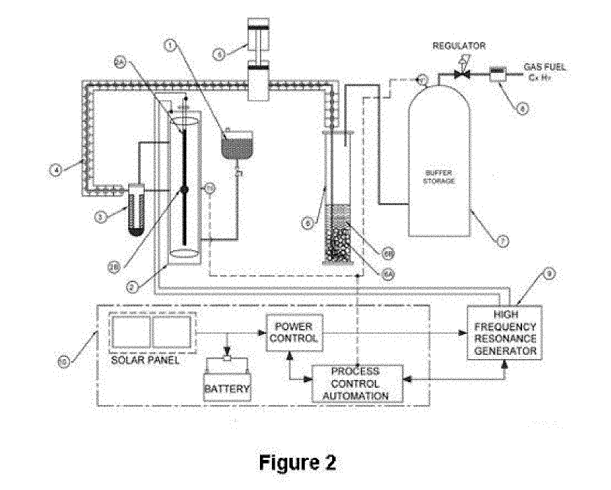

### DETAILED DESCRIPTION OF THE INVENTION

The apparatus of the present invention comprises of a fuel tank (1) wherein process water is kept. The process water is sent to a Catalytic Disambiguation Reactor (CDR) (2). The said reactor (2) also houses the Nickel substrate (2A) and the Nickel-Platinum-Palladium catalyst (2B) and is connected to an Ionic Stabilizer (3), Monatomic Accelerator (4), Active high velocity plunger (5), a Carbon Donor Reactor (CADR) (6). The reactor 6 consists of the Copper Complex Catalyst (6A) and the Carbon Donor Fluid (6B), a Buffer Storage system (7), a Flow Meter (8). The Electronics of the system consist of a High Frequency Resonance Generator (9), tuned to an appropriate frequency, a solar panel, batteries, power control system and all the process control automation (10).

Description of the Components of the System;

Fuel Tank (1); The Primary fuel here is water, the fuel tank is a small tank filled with the process water. Process water is plain drinking water boiled for 20 minutes and cooled to room temperature.

Catalytic Disambiguation Reactor or CDR (2): This is the main reactor of the process. The Reactor shell is made out of Titanium or High quality Stainless steel. The Reactor has a Core of Nickel Substrate coated with Palladium and Platinum.

Ionic Stabilizer (3); Ionic stabilizer consists of Arsenic as catalyst. Ionic stabilizer maintains a balance of nascent atoms for an extended period of time, preventing immediate reaction.

Monatomic Accelerator (4); Protium (for Nascent Hydrogen) and Nascent Oxygen is carried through a special pipeline that is subjected to high polarized field until it reaches a Active High Velocity Plunger.

Active High Velocity Plunger (5); This is a mechanical device that draws the Nascent Hydrogen and Oxygen from the monatomic accelerator and plunges it into the Carbon Donor Reactor (CADR) at high velocity through a cupper complex catalyst.

Carbon Donor Reactor (CADR) (6); This is the second reactor in the process that consist of a carbon donor, like vegetable cooking oil or animal fat, where in the presence of a copper complex catalyst, the nascent oxygen, a highly powerful bond breaker will break the carbon-hydrogen-carbon bonds producing more nascent hydrogen and carbon atoms and soon form small chain hydrocarbons compounds ranging from C₁ to C₈. The mixture of C1 to C8 compounds are stable, remain in gaseous state and are inflammable.

Buffer Storage (7); Thus formed new hydrocarbon or Organic petroleum gas is stored in this buffer storage tank till it is used.

Flow Meter (8): A regulator and a flow meter are used at the gas out let for obvious reasons.

High Frequency Resonator (9); High frequency energy is required for the operation of the Catalytic Disambiguation Reactor. The high frequency resonator provides the required energy, which is regulated by a power control and its related automation.

Solar Panels Power Control, Process Automation (10); Solar panels provide the required energy for the entire system. A power control system charges the battery during the sunshine period, with all the necessary power safety. The process automation controls the entire operation of the system, including maintaining the energy distribution and management, critical process timings, safety and protection etc.

During the process of the present invention, process water from fuel tank (1) is subjected to high frequency resonance at the appropriately tuned frequency inside a reactor (2) that is fitted with a special Nickel-Platinum-Palladium Super Catalyst, where the water disambiguate (takes a new form) into in-statu nascendi or Nascent Hydrogen (H⁺) and Monatomic Oxygen (O⁻). The Nascent species of monatomic hydrogen, which is nothing but protons, is temporally held in an Ionic Stabilizer (3) that contains Arsenic as a catalyst, so that the nascent species that are very short lived is prolonged without mingling with each other. The Nascent Hydrogen and Oxygen species will then start its journey through a system called Monatomic Accelerator, which is subjected through a very high polarized electrical field on the opposite sides, where there is continuous atomic attraction and repulsion. This not only maintains the required atomic states but also accelerates them towards the Active High Velocity Plunger. The Nascent species is then plunged into a reactor holding a carbon source donor such as used vegetable cooking oil or animal fat, in the presence of a copper complex catalyst at high velocity. Here the nascent oxygen species acts first to break the bonds in the vegetable oil/animal fat, then the nascent hydrogen, that is highly reactive will form new bonds resulting in formation of new petroleum hydrocarbon compounds ranging between C₁ to C₈, that is Methane, Ethane, Ethylene, Propane, Propylene, Acetylene, Propadiene, Iso-Butane, n-Butane, Iso-Butylene, Iso-Pentane, n-Pentane, 1-Hexene, n-Hexane, Heptane and Octane. The gas thus formed is stored in a buffer storage tank at a safe pressure and is utilized through a regulator and can be measured through a flow meter.

Hypothesized Principle of the Invention:

Everyone knows that water is made of two parts of Hydrogen and one part of Oxygen. Also everyone knows that when water is electrolyzed it will split into hydrogen (H₂) and oxygen (O₂). But the new discovery and this invention shows that if water is subjected to high frequency oscillations in the presence of Nickel+Platinum+Palladium Catalyst, the water would split into nascent Protium (or nascent hydrogen) and atomic Oxygen (nascent oxygen). These elements in their nascent form is also called disambiguation or newly born. Atomic oxygen, denoted O(³P), O(³P) or O((3)P), is a very good bond breaker; on Earth's surface monatomic oxygen does not exist naturally for very long, though in outer space, the presence of plenty of ultraviolet radiation results in a low Earth orbit atmosphere in which 96% of the oxygen occurs in atomic form.

Nascent (or disambiguative—this state of gases has been named “in-statu nascendi”—Latin, pron. nahstzendee, meaning “in the state of being born”) hydrogen is purported to consist of a chemically reactive form of hydrogen that is freshly generated, hence nascent. Molecular hydrogen (H₂), which is the normal form of this element, is unreactive toward organic compounds, but nascent hydrogen is extremely reactive with carbon found in organic compounds, readily forming single, double and even triple bonds compounds.

The Nascent Protium or NP (for hydrogen), and Atomic Oxygen or AO is maintained in its Nascent form inside a device called the monatomic accelerator, by application of extremely high polarized electric charge and this is also a tube that transports the NP and AO. NP and AO are then plunged into a Carbon (donor) source in the presence of copper complex catalyst at high velocity. The Atomic Oxygen being an excellent bond breaker, would first break the existing bonds in the carbon donor source and the nascent hydrogen will immediately form new bonds with its most liked partner the carbon inside the Carbon Donor Reactor (CADR), the resulting petroleum gas is stored in a buffer storage tank. The gas in the buffer storage tank will be a soup of hydrocarbons ranging from C₁ to C₈ consisting of all most all petroleum gas products starting from Methane to Ethane, Ethylene, Propane, Propylene, Acetylene, Propadiene, Iso-Butane, n-Butane, Iso-Butylene, Iso-Pentane, n-Pentane, 1-Hexene, n-Hexane, Heptane and Octane. By composition, the finally formed gas is chemically same as gases obtained from petroleum or fossil sources, thus it will be called Organic Petroleum Gas. Under normal room temperature, the obtained hydrocarbons are in gasous state and are highly inflammable with high energy density. It can be liquefied by increasing the pressure and/ or reducing temperature appropriately. A large number of freely available carbon sources were used during the trial and testing phase of the invention, which ranged from waste vegetable oil, fresh or new vegetable oils, both edible as well as non-edible.

Application of the Invention;

Though the application of the invention can be very large—from production of small chain hydrocarbons from just water and organic renewable carbon donor sources to production of cooking gas on demand for the millions of people who depend on gaseous hydrocarbon for their basic energy need like cooking and heating. The invention also finds its application in storage of energy produced by renewable sources like wind, solar etc.

The Invention becomes important that, one can study the interaction of water and organic carbon found in nature and investigates the original formation of fossil hydrocarbons. It can also be used to study the formation of hydrocarbons at the beginning of the planets history.

Besides the above, the Invention can provide high calorie fuel for cooking, heating and other energy needs at a fraction of cost, to millions of poor families all over the world. It only needs three to four liters of clean boiled drinking water and 300 grams of used vegetable oil for a whole month's cooking needs of a family (6 hours of cooking). Thousands of square kilometers of infertile land can be used to cultivate non-edible oil plants that can survive in low water and adverse conditions, from which high quality Organic Petroleum Gas can be produced for various energy needs.

High Calorific value of the Organic Petroleum Gas is comparable to Liquid Petroleum Gas (LPG) also ensures that there is no need to change the existing infrastructure for use of the Organic Petroleum Gas in cooking or automobiles.

Trials Conducted with the Invention:

Five liters (5000 ml) of clean water from a domestic reverse osmosis filter was boiled for 20 minutes and cooled to room temperature and put into the Catalytic Disambiguation Reactor. Used vegetable oil was obtained from the canteen. The Used oil contained various types of vegetable oils and was a random mix. The used oil at room temperature was poured into the Carbon donor reactor up to the maximum permissible level; this was around 1500 grams of oil. The reactors were started; pressure inside the reactor was maintained at about 100 milli bar. The reactor was drawing its power from a solar photovoltaic system, after the reactor reached a pressure of 100 milli bar, the active plungers were started and the resultant gas was collected in the buffer storage tank and maintained at a safe pressure of 1.5 bar, the reactor pressure now maintained at −100 milli bar. Gas was first filled in to Gas sample collection bottles supplied by a third party accredited laboratory and was sent for testing, the test results are elaborated here below. The gas was then connected through a regulator to a burner and was ignited. The ignition was smooth and the gas was burnt for 24 hours and in free air uneventfully. The test results confirmed that the gas only contained petroleum hydrocarbon, with very rich calorific content.

After 24 hours of burning with a single burner, the water left in the reactor was measured and found to be 4494 ml, thus a consumption of 506 ml similarly the consumption of oil was about 40 ml. The burner burnt the gas at a rate of 143 grams per hour amounting to approximately 1600 kcal/hour. In 24 hours the energy produced by burning the gas was 38,400 kcal/day.

Results of Tests Done on the New Invention Using Different Types of Vegetable Oils;

The composition of the gas obtained by using different types of used and fresh cooking oil as the donor source is given below. It was also observed that the used vegetable oils produced more of lighter hydrocarbons (like methane), while fresh or virgin vegetable oils produced more of heavier hydrocarbons (like Ethylene, n-Butane), probably because used vegetable oils may have weaker bonds to start with.

The Gas Analysis is Done Using Gas Chromatography by an Accredited Laboratory.

| | Chemical | RMO | SSO | SFO | LO |
|---|---|---|---|---|---|
| Gases | Formula | % | % | % | % |
| Methane | CH₄ | 19.9 | 19.7 | 0.20 | 0.34 |
| Ethane | C₂H₆ | 1.7 | 2.1 | 15.76 | 17.41 |
| Ethylene | C₂H₅ | 1 | 1.2 | 11.52 | 28.33 |
| Propane | C₃H₈ | 3.7 | 1.4 | 14.75 | 4.78 |
| Propylene | C₃H₆ | 0.4 | ND | 5.66 | 3.07 |
| Acetylene | C₂H₂ | 1 | 2.1 | 3.43 | 3.07 |
| Propadiene | C₃H₄ | 2.8 | ND | 1.82 | 2.39 |
| Iso-Butane | C₄H₁₀ | 6.8 | 3.2 | 7.88 | 4.78 |
| n-Butane | C₄H₁₀ | 5.2 | 5.5 | 15.15 | 11.95 |
| Isobutylene | C₄H₈ | 7.4 | 5.1 | 6.87 | 8.19 |
| Iso-Pentane | C₅H₁₂ | 5.3 | 0.3 | 3.23 | 2.05 |
| n-Pentane | C₅H₁₂ | 11 | 4.3 | 2.42 | 3.07 |
| 1 Hexene | C₆H₁₂ | 7.5 | 25.5 | ND | ND |
| n-Hexane | C₆H₁₄ | 10.8 | 10.3 | 3.84 | 4.1 |
| Heptane | C₇H₁₆ | 5.8 | 9.9 | 3.23 | 3.07 |
| Octane | C₈H₁₈ | 9.3 | 8.9 | 3.64 | 2.73 |
| Total | CₓH_{y} | 99.60 | 99.50 | 99.40 | 99.33 |

RMO = Random mixed used vegetable oil::
SSO = Used sesame seed oil::
SFO = Virgin Sunflower Oil::
LO = Virgin vegetable Lamp Oil

Gas Chromatogram of One of the Vegetable Oils Derived Petroleum Hydrocarbons

Approximate Energy Value of the Organic Petroleum Gas Obtained from Random Mixed Used Vegetable Oil (RMO), as a Ttypical Example.

| | Chemical | | | Aprox. Calorific |
|---|---|---|---|---|
| Gases | Formula | Quantity | Unit | Value(Kcal/ltr) |
| Methane | CH₄ | 19.9 | % | 1.74 |
| Ethane | C₂H₆ | 1.7 | % | 0.26 |
| Ethylene | C₂H₅ | 1.0 | % | 0.142 |
| Propane | C₃H₈ | 3.7 | % | 0.82 |
| Propylene | C₃H₆ | 0.4 | % | 0.08 |
| Acetylene | C₂H₂ | 1.0 | % | 0.13 |
| Propadiene | C₃H₄ | 2.8 | % | 0.55 |
| Iso-Butane | C₄H₁₀ | 6.8 | % | 1.99 |
| n-Butane | C₄H₁₀ | 5.2 | % | 1.45 |
| Isobutylene | C₄H₈ | 7.4 | % | 1.70 |
| Iso-Pentane | C₅H₁₂ | 5.3 | % | 1.41 |
| n-Pentane | C₅H₁₂ | 11.0 | % | 2.90 |
| 1 Hexene | C₆H₁₂ | 7.5 | % | 2.38 |
| n-Hexane | C₆H₁₄ | 10.8 | % | 3.02 |
| Heptane | C₇H₁₆ | 5.8 | % | 1.68 |
| Octane | C₈H₁₈ | 9.3 | % | 2.82 |
| Total | CₓH_{y} | 99.60 | % | 23.07 |

Minimum Energy Value would be 23,070 Kcal/M³

1. A Hydro Disambiguative Catalytic Donor Recombination process for producing flammable fuel consisting of C₁ to C₈ hydrocarbons, called as ‘Organic Petroleum Gas’ comprising the steps of:
a) subjecting process water to high frequency resonance inside a reactor equipped with a special Nickel-Platinum-Palladium super catalyst to disambiguate water into nascent Hydrogen (H⁺) and monatomic Oxygen (O⁻);
b) holding the short lived nascent species of monatomic hydrogen in an Ionic Stabilizer containing Arsenic as a catalyst to prolong without mingling with each other;
c) passing the Nascent Hydrogen and Oxygen species through Monatomic Accelerator, which is subjected through a very high polarized electrical field on the opposite sides, where there is continuous atomic attraction and repulsion so as to maintain the required atomic state but also accelerate the said species towards the Active High Velocity Plunger;
d) plunging the nascent species into a reactor holding a carbon source donor such as vegetable oil or animal fat, in the presence of a copper complex catalyst at high velocity to produce the flammable fuel consisting of C₁ to C₈ hydrocarbons;
e) storing the gas thus formed in a buffer storage tank at a safe pressure.

2. The process as claimed in claim 1, wherein the flammable fuel obtained consists of C₁ to C₈ hydrocarbons Methane, Ethane, Ethylene, Propane, Propylene, Acetylene, Propadiene, Iso-Butane, n-Butane, Iso-Butylene, Iso-Pentane, n-Pentane, 1-Hexene, n-Hexane, Heptane and Octane.

3. The process as claimed in claim 1, wherein the process water is plain drinking water boiled for 20 minutes and cooled to room temperature.

4. The process as claimed in claim 1, wherein the flammable fuel stored in the buffer storage tank is utilized though a regulator including a flow meter to measure the quantity of the gas.

5. A Hydro Disambiguative Catalytic Donor Recombination apparatus for producing flammable fuel consisting of C₁ to C₈ hydrocarbons, called as ‘Organic Petroleum Gas’ comprising of:
a) a fuel tank to store process water;
b) a catalytic disambiguation reactor connected to a high frequency resonator to subject the process water to high frequency resonance inside the said reactor which is equipped with a special Nickel-Platinum-Palladium super catalyst to disambiguate water into nascent Hydrogen (H⁺) and monatomic Oxygen (O⁻);
c) an Ionic Stabilizer containing Arsenic as a catalyst to hold the short lived nascent species of monatomic hydrogen to prolong without mingling with each other;
d) a Monatomic Accelerator which is subjected through a very high polarized electrical field on the opposite sides, where there is continuous atomic attraction and repulsion to pass the Nascent Hydrogen and Oxygen species so as to maintain the required atomic state but also accelerate the said species towards an Active High Velocity Plunger;
e) a carbon donor reactor holding a carbon source donor such as vegetable oil or animal fat, in the presence of a copper complex catalyst at high velocity wherein the accelerated Nascent Hydrogen and Oxygen species are plunged to produce the flammable fuel consisting of C₁ to C₈ hydrocarbons;
f) a buffer storage tank to store the gas thus formed in at a safe pressure.

6. The apparatus as claimed in claim 5, including solar panels to provide the required energy for operating the said apparatus, a power control system to charge the battery, process automation controls to enable operation of the system, including maintaining the energy distribution and management, critical process timings, safety and protection, etc.

7. The apparatus as claimed in claim 5, wherein the catalytic disambiguation reactor is made of either Titanium or high quality stainless steel and the super catalyst is a core of Nickel Substrate coated with Palladium and Platinum.

8. The apparatus as claimed in claim 5, wherein the monatomic accelerator is a special pipeline that is subjected to high polarized electrical field.

9. The apparatus as claimed in claim 5, wherein the high frequency resonator provides the required energy, which is regulated by a power control and its related automation.
